(19) United States
(12) Patent Application Publication
(10) Pub. No.: US 2025/0239905 A1
(43) Pub. Date: Jul. 24, 2025

(54) BLOWER

(71) Applicant: MITSUBISHI HEAVY INDUSTRIES THERMAL SYSTEMS, LTD., Tokyo (JP)

(72) Inventors: Yasuhiro WATANABE, Tokyo (JP); Atsushi SUZUKI, Tokyo (JP)

(73) Assignee: MITSUBISHI HEAVY INDUSTRIES THERMAL SYSTEMS, LTD., Tokyo (JP)

(21) Appl. No.: 18/853,305

(22) PCT Filed: Mar. 9, 2023
(86) PCT No.: PCT/JP2023/009061

§ 371 Date: Oct. 1, 2024

(30) Foreign Application Priority Data
Apr. 25, 2022 (JP) 2022-071627

(51) Int. Cl. H02K 5/10; F04D 17/16; F04D 25/06; F04D 29/42

(52) U.S. Cl. CPC H02K 5/10; F04D 17/16; F04D 25/0606; F04D 29/4226

(57) ABSTRACT

A blower includes: a motor including a motor shaft; a centrifugal fan connected to the motor shaft and rotated about an axis of the motor shaft by output of the motor; and a motor casing including a cylindrical part covering the motor from a side opposite to the centrifugal fan in an axial direction. The motor casing includes, outside an outside surface of the cylindrical part, a flanged rib extending outward in the radial direction of the axis.

### TECHNICAL FIELD

The present disclosure relates to a blower.

This application claims priority based on Japanese Patent Application No. 2022-071627 filed in Japan on Apr. 25, 2022, the contents of which are incorporated herein.

### BACKGROUND ART

Patent Document 1 discloses an intake unit which includes a suction port, a discharge port, and a fan incorporated to suck air from the suction port and blow the air toward the discharge port.

### CITATION LIST

### Patent Literature

Patent Document 1: JP 02-135700 UM-B

### SUMMARY OF INVENTION

### Technical Problem

However, the intake unit described in Patent Document 1 has a problem in that water having entered from the outside through the suction port enters the inside of a motor.

The present disclosure has been made to solve the above-described problem, and an object of the present disclosure is to provide a blower that can suppress entry of water into the inside of a motor.

### Solution to Problem

To solve the above-described problem, a blower according to the present disclosure includes: a motor including a motor shaft; a centrifugal fan connected to the motor shaft and rotated about an axis of the motor shaft by output of the motor; and a motor casing including a cylindrical part covering the motor from a side opposite to the centrifugal fan in a direction of the axis. The motor casing includes, outside an outside surface of the cylindrical part, a flanged rib extending outward in a radial direction of the axis.

### Advantageous Effects of Invention

The blower of the present disclosure can suppress entry of water into the inside of the motor.

### BRIEF DESCRIPTION OF DRAWINGS

FIG. 1 is a side view of an air conditioner according to an embodiment of the present disclosure.

FIG. 2 is a top view of the air conditioner according to the embodiment of the present disclosure.

FIG. 3 is a side view of a blower according to the embodiment of the present disclosure.

FIG. 4 is an exploded perspective view of the blower according to the embodiment of the present disclosure.

FIG. 5 is a top view of the blower according to the embodiment of the present disclosure.

FIG. 6 is an enlarged perspective view of a sloped part according to the embodiment of the present disclosure.

FIG. 7 is a side view of a blower according to a first modification example of the present disclosure.

FIG. 8 is a side view of a blower according to a second modification example of the present disclosure.

FIG. 9 is a side view of a blower according to a third modification example of the present disclosure.

FIG. 10 is a side view of a blower according to a fourth modification example of the present disclosure.

FIG. 11 is a side view of a blower according to a fifth modification example of the present disclosure.

### DESCRIPTION OF EMBODIMENTS

### Air Conditioner

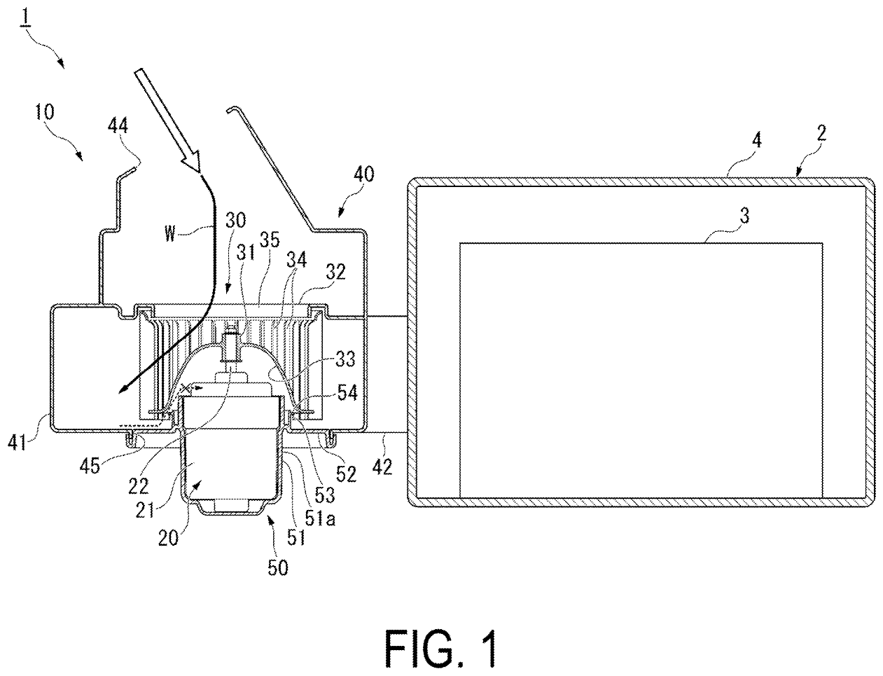

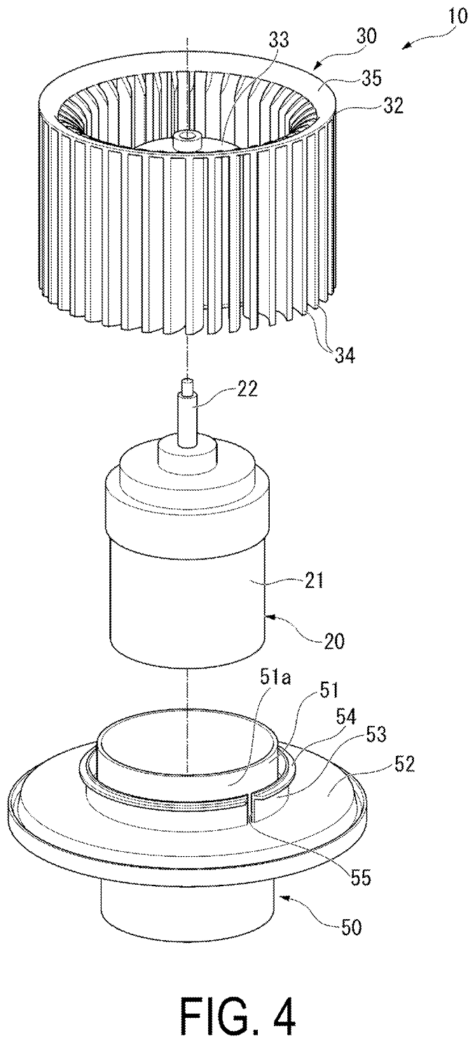

Hereinafter, an air conditioner 1 provided with a blower 10 according to an embodiment of the present disclosure will be described with reference to FIG. 1 to FIG. 6.

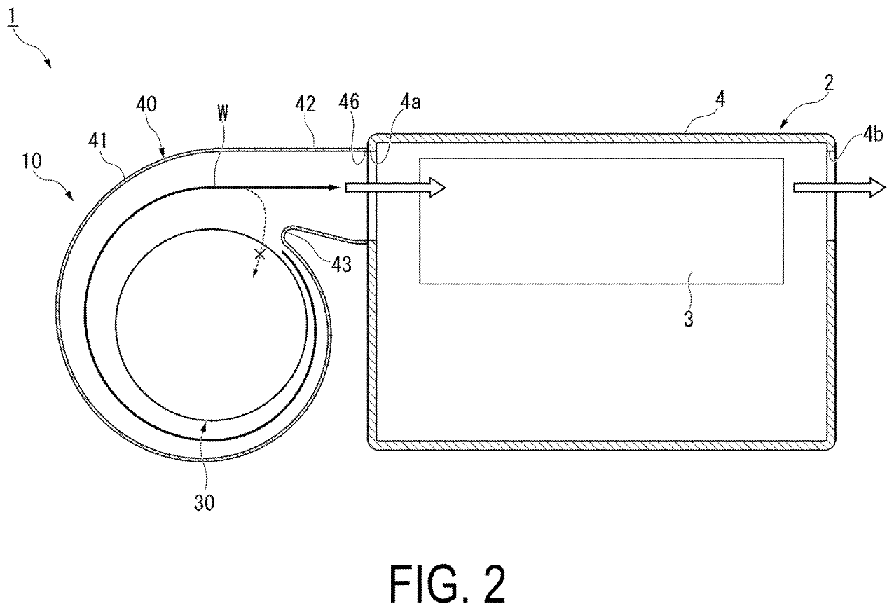

The air conditioner 1 illustrated in FIG. 1 and FIG. 2 is mounted on a vehicle, for example.

The air conditioner 1 includes a heat exchanger 2 and the blower 10.

### Heat Exchanger

The heat exchanger 2 includes a heat exchanger main body 3 and a heat exchanger casing 4.

The heat exchanger main body 3 exchanges heat with air supplied from the blower 10 to produce hot air or cold air.

The heat exchanger main body 3 is incorporated in the heat exchanger casing 4.

The heat exchanger casing 4 includes a supply port 4a and a discharge port 4b.

The supply port 4a supplies air from the blower 10 to the inside of the heat exchanger casing 4. The discharge port 4b discharges hot air or cold air produced by the heat exchanger 2 to the outside of the heat exchanger casing 4.

### Blower

The blower 10 supplies air to the heat exchanger 2.

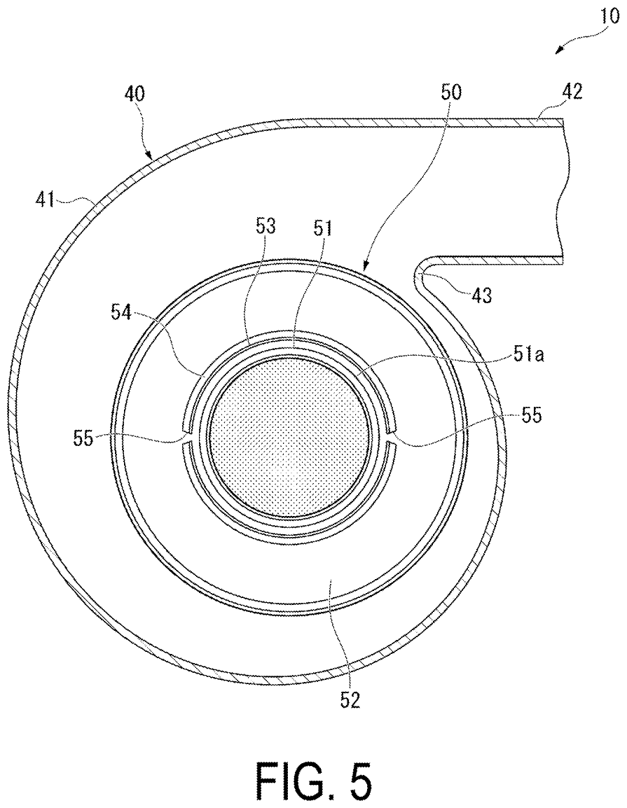

As illustrated in FIG. 2 to FIG. 5, the blower 10 includes a motor 20, a centrifugal fan 30, a scroll casing 40, and a motor casing 50. In FIG. 2, a detailed configuration inside the scroll casing 40 of the blower 10 is omitted, and only the centrifugal fan 30 is illustrated in a simplified manner as a simple circle. In FIG. 5, the motor 20 and the centrifugal fan 30 are omitted, and a bottom part of a cylindrical part 51 of the motor casing 50 is illustrated.

### Motor

The motor 20 includes a motor main body 21 and a motor shaft 22.

The motor main body 21 is formed in a cylindrical shape.

The motor shaft 22 is formed coaxially with the motor main body 21. The motor shaft 22 extends in one direction.

Hereinafter, an axis O of the motor shaft 22 may be simply referred to as an “axis O”. A direction of the axis O of the motor 20 may be simply referred to as an “axis O direction”, a radial direction of the axis O may be simply referred to as a “radial direction”, and a circumferential direction of the axis O may be referred to as a “circumferential direction”.

### Centrifugal Fan

The centrifugal fan 30 is, for example, a sirocco fan. The centrifugal fan 30 is connected to the motor shaft 22 and is rotated about the axis O by output of the motor 20.

The centrifugal fan 30 includes a fan shaft 31, a multistage blade part 32, and a connection part 33.

The fan shaft 31 extends in the axis O direction and is connected to the motor shaft 22.

The multistage blade part 32 is provided outside the fan shaft 31 in the radial direction.

The multistage blade part 32 includes a blade part 34 and an annular part 35.

A plurality of blade parts 34 are provided at equal intervals in the circumferential direction. The blade part 34 is formed in a rod shape extending in the axis O direction. Both end parts of the blade part 34 in the axis O direction are located on both outer sides of the fan shaft 31 in the axis O direction, respectively.

A pair of annular parts 35 are provided on both sides of the plurality of blade parts 34 in the axis O direction. The annular part 35 is annularly shaped extending in the circumferential direction. The annular parts 35 connect end parts of the plurality of blade parts 34.

The connection part 33 is provided between the fan shaft 31 and the multistage blade part 32. The connection part 33 connects the fan shaft 31 and the multistage blade part 32 in the radial direction. A plurality of connection parts 33 are provided for the respective blade parts 34. The plurality of blade parts 34 are arranged at equal intervals in the circumferential direction. The connection part 33 is formed in an arch shape that approaches the fan shaft 31 from the blade part 34 inward in the radial direction in a side view.

### Scroll Casing

The centrifugal fan 30 is incorporated in the scroll casing 40.

The scroll casing 40 includes a first compartment 41, a second compartment 42, and a nose part 43.

### First Compartment

The centrifugal fan 30 is incorporated in the first compartment 41.

The first compartment 41 includes a suction port 44 and a fitting port 45.

The suction port 44 opens on a side opposite to the motor 20 across the centrifugal fan 30 in the axis O direction.

The fitting port 45 opens on a side opposite to the suction port 44 across the centrifugal fan 30 in the axis O direction.

### Second Compartment

The second compartment 42 communicates with the first compartment 41.

The second compartment 42 includes a discharge port 46.

The discharge port 46 opens on a side opposite to the first compartment 41 in a direction intersecting the axis O direction. The discharge port 46 is connected to the supply port 4a of the heat exchanger 2.

The first compartment 41 and the second compartment 42 form a flow path of an air flow generated by the centrifugal fan 30 from the suction port 44 to the discharge port 46.

### Nose Part

The nose part 43 is provided at a connection part between the first compartment 41 and the second compartment 42. The nose part 43 protrudes into the flow path in the scroll casing 40. The nose part 43 rectifies the air flow generated by the centrifugal fan 30 from the suction port 44 and guides the air flow to the discharge port 46.

### Motor Casing

The motor casing 50 is provided on a side opposite to the centrifugal fan 30 across the motor 20 in the axis O direction. The motor casing 50 is a member that accommodates the motor 20. The motor casing 50 is formed of a resin material.

The motor casing 50 includes a cylindrical part 51, a flange 52, an outer circumferential rib 53, and a flanged rib 54.

### Cylindrical Part

The cylindrical part 51 is a bottomed cylindrical member extending in the axis O direction. The cylindrical part 51 covers the motor 20 from a side opposite to the centrifugal fan 30 in the axis O direction. In the present embodiment, the cylindrical part 51 is formed in a cylindrical shape.

### Flange

The flange 52 is provided over the entire circumference of an outside surface 51a of the cylindrical part 51. The flange 52 extends outward in the radial direction from the outside surface 51a of the cylindrical part 51. The flange 52 is fitted into the fitting port 45 of the scroll casing 40. The fitting port 45 is closed by the flange 52.

### Outer Circumferential Rib

The outer circumferential rib 53 is provided outside the outside surface 51a of the cylindrical part 51. The outer circumferential rib 53 is separated outward in the radial direction from the cylindrical part 51. The outer circumferential rib 53 is annularly shaped when viewed from the axis O direction. The outer circumferential rib 53 extends in the axis O direction. The height of the outer circumferential rib 53 is lower than the height of the cylindrical part 51.

### Flanged Rib

The flanged rib 54 is provided outside the outside surface 51a of the cylindrical part 51. In the present embodiment, the flanged rib 54 is provided on the outer circumferential rib 53 on the outermost side in the radial direction. The flanged rib 54 extends outward in the radial direction of the axis O and in a direction perpendicular to the axis O direction. The flanged rib 54 is annularly shaped when viewed from the axis O direction and is provided at a position corresponding to the nose part 43. That is, the flanged rib 54 is provided at a position close to the nose part 43.

### Slit

A slit 55 is formed in the outer circumferential rib 53 and the flanged rib 54. A pair of slits 55 are provided at positions separated from each other by 180 degrees about the axis O. The slit 55 penetrates the outer circumferential rib 53 in the radial direction and penetrates the flanged rib 54 in the axis O direction.

### Slope

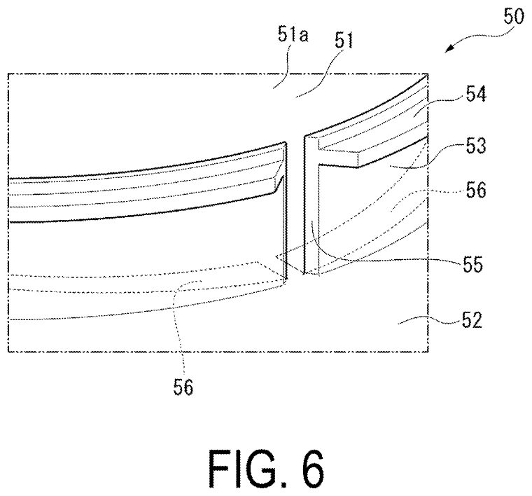

As illustrated in FIG. 6, a slope 56 is provided between the cylindrical part 51 and the outer circumferential rib 53. The slope 56 is formed to extend in the circumferential direction. The slope 56 is formed so as to approach the flange 52 as approaching the slit 55.

### Operational Effects

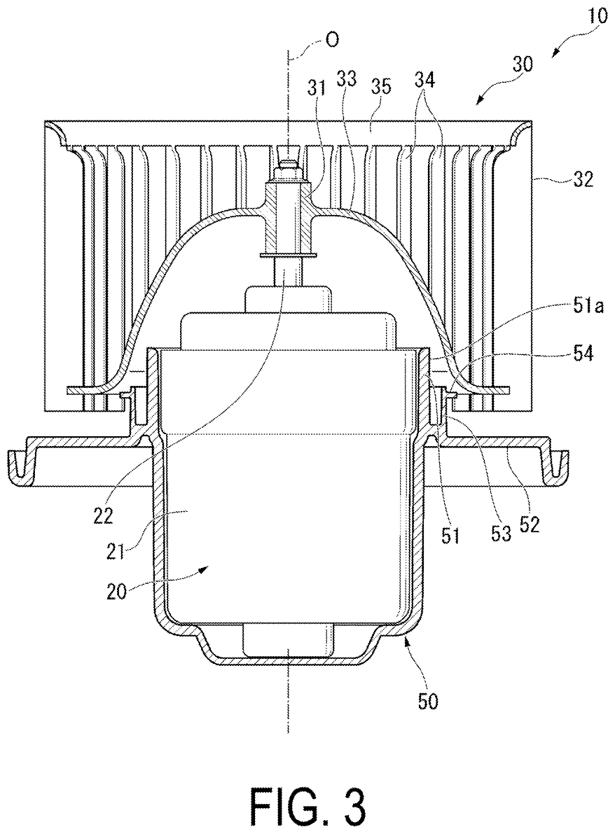

Next, an operation of the blower 10 will be described with reference to FIG. 2 and FIG. 3.

The centrifugal fan 30 is rotated about the axis O by the output of the motor 20, causing external air to be sucked into the centrifugal fan 30 through the suction port 44. The air sucked into the centrifugal fan 30 is discharged outward in the radial direction of the centrifugal fan 30. Thus, an air flow is generated in the first compartment 41 of the scroll casing 40. The air flow is rectified by the nose part 43 to be a flow from the first compartment 41 toward the second compartment 42.

However, at the nose part 43, an air flow toward the center of the motor 20 is generated due to backflow. When water W enters the inside of the scroll casing 40 from the suction port 44, the entered water W tries to enter the inside of the motor 20 by the flow toward the center of the motor 20.

On the other hand, in the blower 10 of the present embodiment, the flanged rib 54 and the outer circumferential rib 53 are installed, allowing for suppressing entry of the water W into the inside of the motor 20. Hereinafter, the operation and effects of each component of the blower 10 will be described in detail.

In the present embodiment, the motor casing 50 includes the cylindrical part 51 that covers the motor 20 from a side opposite to the centrifugal fan 30 in the axis O direction, and the flanged rib 54 that extends outward in the radial direction of the axis O on the outer side of the outside surface 51a of the cylindrical part 51.

According to the present embodiment, the blower 10 can block the water W which is entering the inside of the motor 20 with the cylindrical part 51. Further, the blower 10 can more reliably block, with the flanged rib 54, the water W which tries to go beyond the cylindrical part 51 and enter the inside of the motor 20. In this way, the blower 10 can suppress entry of water W into the inside of the motor 20 with the cylindrical part 51 and the flanged rib 54.

In the present embodiment, the flanged rib 54 extends in a direction perpendicular to the axis O direction.

According to the present embodiment, the flanged rib 54 more easily blocks the water W which tries to enter the inside of the motor 20 as compared with a case in which the flanged rib 54 extends toward the centrifugal fan 30. Accordingly, the blower 10 can more reliably suppress entry of water W into the inside of the motor 20.

The flanged rib 54 can be formed more easily as compared with a case in which the flanged rib 54 extends toward the centrifugal fan 30. For example, the flanged rib 54 can be formed with a mold mechanism such as a slide core to minimize the increase in the cost of the blower 10.

In the present embodiment, the flanged rib 54 is annularly shaped when viewed from the axis O direction.

According to the present embodiment, the flanged rib 54 can block the water W which tries to enter the inside of the motor 20 over the entire circumference of the cylindrical part 51. Accordingly, the blower 10 can more reliably suppress entry of water W into the inside of the motor 20.

In the present embodiment, the motor casing 50 further includes the outer circumferential rib 53 that is annularly shaped when viewed from the axis O direction and extends in the axis O direction, on the outer side of the outside surface 51a of the cylindrical part 51.

According to the present embodiment, the blower 10 can block, with the outer circumferential rib 53 the water W which tries to go beyond the cylindrical part 51 and enter the inside of the motor 20. Accordingly, the blower 10 can more reliably suppress entry of water W into the inside of the motor 20.

In the present embodiment, the flanged rib 54 is provided on the outer circumferential rib 53 on the outermost side in the radial direction.

According to the present embodiment, the blower 10 can block a flow which tries to enter the inside of the motor 20 with flanged rib 54 at a position separated from the cylindrical part 51 outward in the radial direction. Accordingly, the blower 10 can more reliably suppress entry of water W into the inside of the motor 20.

The flanged rib 54 can be easily formed. For example, the flanged rib 54 can be formed with a mold mechanism such as a slide core to minimize the increase in the cost of the blower 10.

In the present embodiment, the outer circumferential rib 53 includes the slits 55 penetrating the outer circumferential rib 53 in the radial direction.

According to the present embodiment, the blower 10 can discharge the water W accumulated between the cylindrical part 51 and the outer circumferential rib 53 to the outside of the outer circumferential rib 53 through the slits 55. Thus, the blower 10 can suppress the water W accumulated between the cylindrical part 51 and the outer circumferential rib 53 from going beyond the cylindrical part 51 and entering the inside of the motor 20.

In the present embodiment, the blower 10 includes the scroll casing 40 which includes the suction port 44, the discharge port 46, and the centrifugal fan 30 incorporated.

According to the present embodiment, an air flow in the blower 10 can be set in any direction depending on the arrangement of the suction port 44 and the discharge port 46. Further, even in a case where the water W tries to enter the inside of the motor 20 with the air flow generated in the scroll casing 40, the flanged rib 54 can block the water W. In this way, the blower 10 can suppress entry of the water W into the inside of the motor 20 with the flanged rib 54 while setting the air flow in any direction with the scroll casing 40.

In the present embodiment, the flanged rib 54 is provided at a position corresponding to the nose part 43 of the scroll casing 40.

At the nose part 43, the air flow generated by the centrifugal fan 30 is reversed to produce an air flow toward the center of the motor 20. According to the present embodiment, the flanged rib 54 can block the water W which tries to enter the inside of the motor 20 due to the air flow toward the center of the motor 20. Accordingly, the blower 10 can more reliably suppress entry of water W into the inside of the motor 20.

### First Modification Example

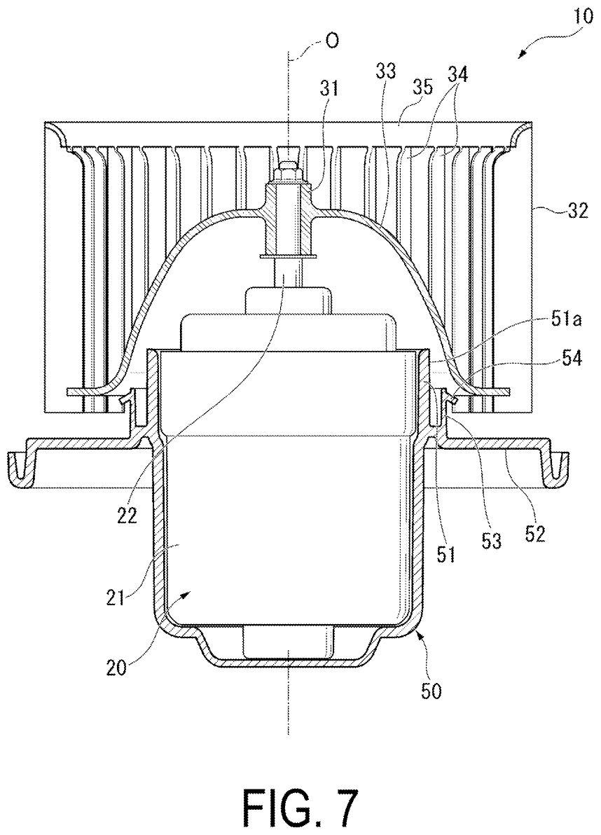

Hereinafter, the blower 10 according to a first modification example of the present disclosure will be described with reference to FIG. 7.

As illustrated in FIG. 7, in the present modification, the flanged rib 54 is provided so as to be inclined with respect to the cylindrical part 51 and the outer circumferential rib 53. More specifically, the flanged rib 54 is provided at the outer circumferential rib 53 and is inclined while being gradually separated from the centrifugal fan 30 outward in the radial direction.

The flanged rib 54 is desirably a part separate from the cylindrical part 51 and the outer circumferential rib 53. In this case, an annular rib inclined with respect to the cylindrical part 51 and the outer circumferential rib 53 can be formed relatively easily.

Note that the flanged rib 54 may be inclined so as to gradually approach the centrifugal fan 30 outward in the radial direction.

The flanged rib 54 may be provided on the cylindrical part 51.

### Second Modification Example

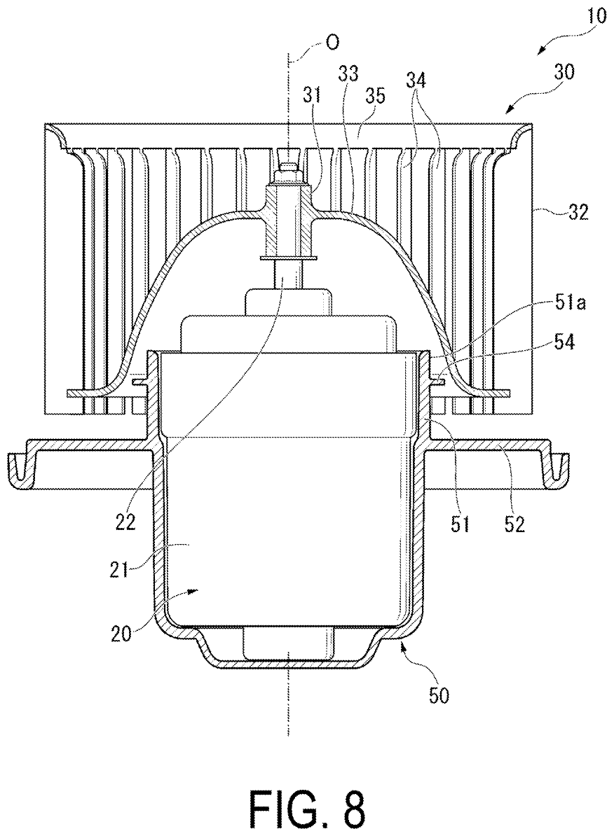

Hereinafter, the blower 10 according to a second modification example of the present disclosure will be described with reference to FIG. 8.

As illustrated in FIG. 8, in the present modification, the outer circumferential rib 53 is not provided outside the outside surface 51a of the cylindrical part 51, and the flanged rib 54 is provided on the outside surface 51a of the cylindrical part 51.

### Third Modification Example

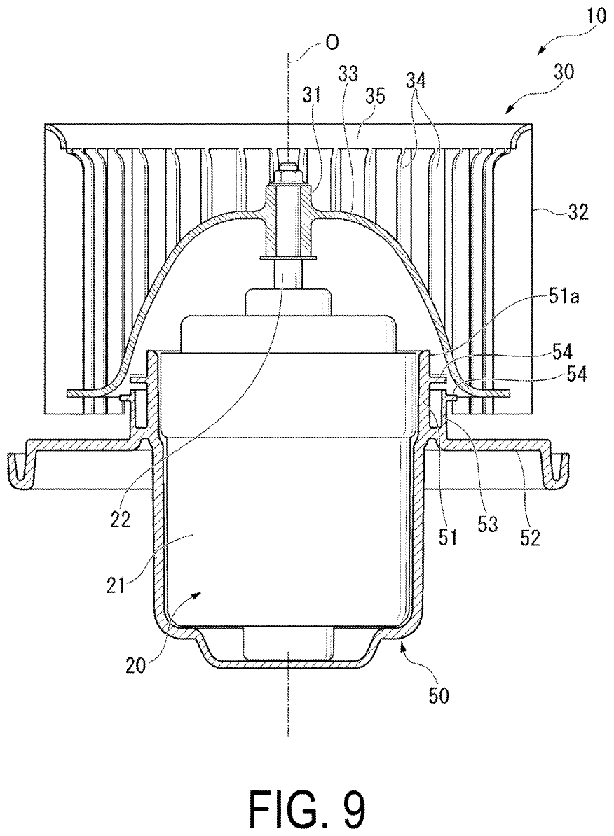

Hereinafter, the blower 10 according to a third modification example of the present disclosure will be described with reference to FIG. 9.

As illustrated in FIG. 9, in the present modification, a plurality of flanged ribs 54 are provided. More specifically, the flanged rib 54 is provided on each of the cylindrical part 51 and the outer circumferential rib 53.

According to the present modification example, the blower 10 can more suitably block the water W which tries to enter the inside of the motor 20 with the flanged ribs 54 as compared with a case in which only one flanged rib 54 is provided. Accordingly, the blower 10 can more reliably suppress entry of water W into the inside of the motor 20.

The number of the flanged ribs 54 can be changed as appropriate depending on the design of the blower 10.

### Fourth Modification Example

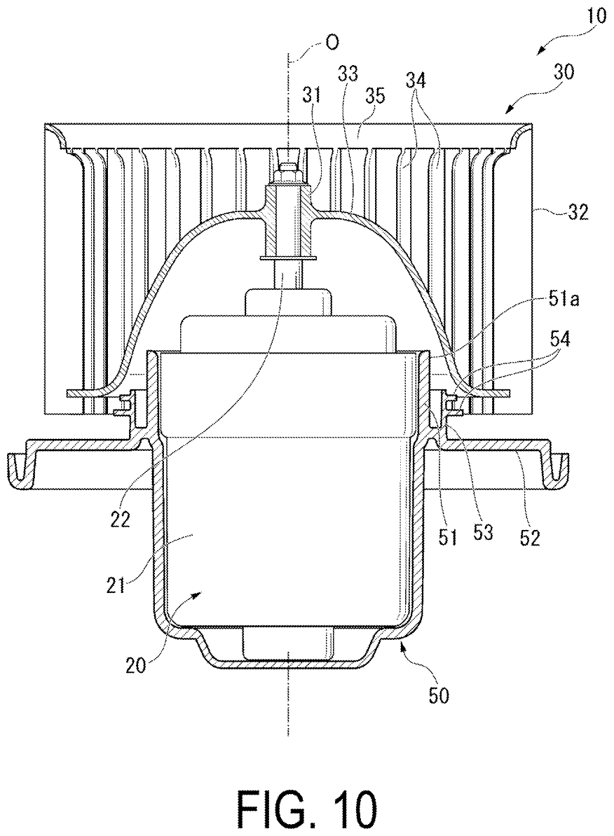

Hereinafter, the blower 10 according to a fourth modification example of the present disclosure will be described with reference to FIG. 10.

As illustrated in FIG. 10, in the present modification, a plurality of flanged ribs 54 are provided. More specifically, two flanged ribs 54 are provided on the outer circumferential rib 53. The two flanged ribs 54 are provided so as to be spaced from each other in the axis O direction.

The blower 10 according to the present modification example can achieve the same operational effects as the blower 10 according to the third modification example.

The number of the flanged ribs 54 can be changed as appropriate depending on the design of the blower 10.

### Fifth Modification Example

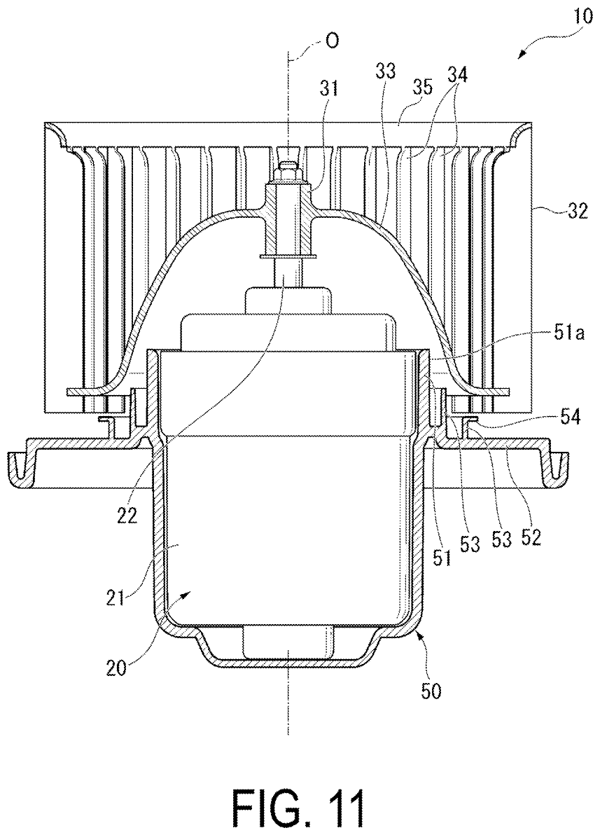

Hereinafter, the blower 10 according to a fifth modification example of the present disclosure will be described with reference to FIG. 11.

As illustrated in FIG. 11, in the present modification, a plurality of layers of the outer circumferential ribs 53 are provided side by side in the radial direction. More specifically, two outer circumferential ribs 53 are provided side by side in the radial direction.

The flanged rib 54 is provided on the outer circumferential rib 53 on the outermost side in the radial direction out of the plurality of layers of the outer circumferential ribs 53.

In the present modification example, the plurality of layers of the outer circumferential ribs 53 are provided side by side in the radial direction.

Thus, the blower 10 can more suitably block the water W which tries to enter the inside of the motor 20 with the plurality of layers of the outer circumferential ribs 53 as compared with a case in which only one outer circumferential rib 53 is provided. Accordingly, the blower 10 can more reliably suppress entry of water W into the inside of the motor 20.

The number of layers of the outer circumferential ribs 53 can be changed as appropriate depending on the design of the blower 10.

### Other Embodiments

The embodiments according to the present disclosure have been described in detail with reference to the drawings. However, the specific configuration of the present disclosure is not limited to these embodiments, and also includes a design change or the like without departing from the gist of the present disclosure.

In the embodiments described above, the flanged rib 54 is annularly shaped when viewed from the axis O direction, but the shape is not limited to this. The flanged rib 54 may be provided only at a position corresponding to a part of the outside surface 51a of the cylindrical part 51. That is, the flanged rib 54 may be provided only at a position corresponding to the nose part 43.

In the embodiments described above, the blower 10 includes the scroll casing 40, but the configuration is not limited to this. The blower 10 need not include the scroll casing 40. Even when the scroll casing 40 is not provided, air may flow back to the center of the motor 20 along the flange 52 of the motor casing 50, for example, when an obstacle that blocks air flow generated by the centrifugal fan 30 is arranged near the centrifugal fan 30, or when a strong air flow is generated near the centrifugal fan 30 due to an external factor. Even when the water W tries to enter the inside of the motor 20 due to such backflow of the air, the blower 10 can block the water W with the flanged rib 54.

### Supplementary Notes

The blower 10 according to each embodiment is understood as follows, for example.

(1) A blower 10 according to a first aspect includes: a motor 20 including a motor shaft 22; a centrifugal fan 30 connected to the motor shaft 22 and rotated about an axis O of the motor shaft 22 by output of the motor 20; and a motor casing 50 including a cylindrical part 51 covering the motor 20 from a side opposite to the centrifugal fan 30 in a direction of the axis O. The motor casing 50 includes a flanged rib 54 extending outward in a radial direction of the axis O on an outer side of an outside surface 51a of the cylindrical part 51.

According to the present aspect, the blower 10 can block, with the flanged rib 54, water W which tries to go beyond the cylindrical part 51 and enter the inside of the motor 20.

(2) A blower 10 according to a second aspect is the blower 10 of (1), wherein the flanged rib 54 may extend in a direction perpendicular to the direction of the axis O.

According to the present aspect, the flanged rib 54 more easily blocks the water W which tries to enter the inside of the motor 20 as compared with a case in which the flanged rib 54 extends toward the centrifugal fan 30. The flanged rib 54 can be formed more easily as compared with a case in which the flanged rib 54 extends toward the centrifugal fan 30.

(3) A blower 10 according to a third aspect is the blower 10 of (1) or (2), wherein the flanged rib 54 may be annularly shaped when viewed from the direction of the axis O.

According to the present aspect, the flanged rib 54 can block the water W which tries to enter the inside of the motor 20 over the entire circumference of the cylindrical part 51.

(4) A blower 10 according to a fourth aspect is the blower 10 of any one of (1) to (3), wherein the motor casing 50 further includes, outside the outside surface 51a of the cylindrical part 51, an outer circumferential rib 53 that is annularly shaped when viewed from the direction of the axis O and extends in the direction of the axis O.

According to the present aspect, the blower 10 can block, with the outer circumferential rib 53, the water W which tries to go beyond the cylindrical part 51 and enter the inside of the motor 20.

(5) A blower 10 according to a fifth aspect is the blower 10 of (4), wherein the flanged rib 54 may be provided on the outer circumferential rib 53 on an outermost side in the radial direction.

According to the present aspect, the blower 10 can block a flow which tries to enter the inside of the motor 20 with the flanged rib 54 at a position separated from the cylindrical part 51 outward in the radial direction. The flanged rib 54 can be easily formed.

(6) A blower 10 according to a sixth aspect is the blower 10 of (4) or (5), wherein the outer circumferential rib 53 includes a slit 55 penetrating the outer circumferential rib 53 in the radial direction.

According to the present aspect, the blower 10 can discharge the water W accumulated between the cylindrical part 51 and the outer circumferential rib 53 to the outside of the outer circumferential rib 53 through the slit 55.

(7) A blower 10 according to a seventh aspect is the blower 10 of any one of (1) to (6), wherein a plurality of the flanged ribs 54 may be provided.

According to the present aspect, the blower 10 can more suitably block the water W which tries to enter the inside of the motor 20 with the flanged ribs 54 as compared with a case in which only one flanged rib 54 is provided.

(8) A blower 10 according to an eighth aspect is the blower 10 of any one of (1) to (7), further including a scroll casing 40 including the centrifugal fan 30 incorporated, a suction port 44 opening on a side opposite to the motor 20 across the centrifugal fan 30 in the direction of the axis O, and a discharge port 46 opening in a direction intersecting the direction of the axis O.

According to the present aspect, an air flow in the blower 10 can be set in any direction depending on the arrangement of the suction port 44 and the discharge port 46. Further, even in a case where the water W tries to enter the inside of the motor 20 with the air flow generated in the scroll casing 40, the flanged rib 54 can block the water W.

(9) A blower 10 according to a ninth aspect is the blower 10 of (8), wherein the flanged rib 54 may be provided at a position corresponding to a nose part 43 of the scroll casing 40.

At the nose part 43, the air flow generated by the centrifugal fan 30 is reversed to produce an air flow toward the center of the motor 20. According to the present aspect, the flanged rib 54 can block the water W which tries to enter the inside of the motor 20 due to the air flow toward the center of the motor 20.

### INDUSTRIAL APPLICABILITY

The blower of the present disclosure can suppress entry of water into the inside of the motor.

### REFERENCE SIGNS LIST

1 Air conditioner, 2 Heat exchanger, 3 Heat exchanger main body, 4 Heat exchanger casing, 4a Supply port, 4b Discharge port, 10 Blower, 20 Motor, 21 Motor main body, 22 Motor shaft, 30 Centrifugal fan, 31 Fan shaft, 32 Multistage blade part, 33 Connection part, 34 Blade part, 35 Annular part, 40 Scroll casing, 41 First compartment, 42 Second compartment, 43 Nose part, 44 Suction port, 45 Fitting port, 46 Discharge port, 50 Motor casing, 51 Cylindrical part, 51a Outside surface, 52 Flange, 53 Outer circumferential rib, 54 Flanged rib, 55 Slit, 56 Slope, O Axis, W Water

1. A blower, comprising:
a motor including a motor shaft;
a centrifugal fan connected to the motor shaft and rotated about an axis of the motor shaft by output of the motor; and
a motor casing including a cylindrical part covering the motor from a side opposite to the centrifugal fan in a direction of the axis, wherein
the motor casing includes, outside an outside surface of the cylindrical part, a flanged rib extending outward in a radial direction of the axis.

2. The blower according to claim 1, wherein the flanged rib extends in a direction perpendicular to the direction of the axis.

3. The blower according to claim 1, wherein the flanged rib is annularly shaped when viewed from the direction of the axis.

4. The blower according to claim 1, wherein the motor casing further includes, outside the outside surface of the cylindrical part, an outer circumferential rib that is annularly shaped when viewed from the direction of the axis and extends in the direction of the axis.

5. The blower according to claim 4, wherein the flanged rib is provided on the outer circumferential rib on an outermost side in the radial direction.

6. The blower according to claim 4, wherein the outer circumferential rib includes a slit penetrating the outer circumferential rib in the radial direction.

7. The blower according to claim 1, wherein a plurality of the flanged ribs are provided.

8. The blower according to claim 1, further comprising a scroll casing including the centrifugal fan incorporated, a suction port opening on a side opposite to the motor across the centrifugal fan in the direction of the axis, and a discharge port opening in a direction intersecting the direction of the axis.

9. The blower according to claim 8, wherein the flanged rib is provided at a position corresponding to a nose part of the scroll casing.
